(19) United States
(12) Patent Application Publication
(10) Pub. No.: US 2010/0204839 A1
(43) Pub. Date: Aug. 12, 2010

(54) METHOD AND APPARATUS FOR THE MONITORING OF WATER USAGE WITH PATTERN RECOGNITION

(75) Inventors: Gary W. Behm, Hopewell Junction, NY (US); Al J. Noll, Poughkeepsie, NY (US)

Correspondence Address: INTERNATIONAL BUSINESS MACHINES CORPORATION;DEPT. 18G, BLDG. 321-482, 2070 ROUTE 52, HOPEWELL JUNCTION, NY, 12533, US

(73) Assignee: International Business Machines Corporation, Armonk, NY (US)

(21) Appl. No.: 12/367,563

(22) Filed: Feb. 9, 2009

(51) Int. Cl. G05D 7/00

(52) U.S. Cl. 700/282

(57) ABSTRACT

A method for monitoring water usage in a home or business through the use of pattern recognition. Wherein the system monitors water flow through a valve and monitors usage over a period of time to determine normal usage. Once a normal pattern of usage is determined the system monitors pattern usage over time and determines if the pattern of usage exceeds cutoffs. In the event the usage exceeds the cutoffs the system produces an alarm and shuts off the valve. Once the cause for the system cutoff has been determined the cause may be corrected and the valve reopened.

### BACKGROUND

Water leaks can wreak havoc for homeowners or businesses. If the leak is not discovered quickly, the loss in man hours and repairs can be extensive, in addition to the damage from water leak. There are numerous potential causes and locations of water leaks. These include water accidentally left running, broken fixtures, broken water pipes and/or heating pipes, broken appliances and valve leaks.

As an example, toilets have a stopper valve to prevent water from flowing from the tank to the bowl. Over time the stopper often degrades as the minerals in the water degrade the stopper material. The result is a toilet that runs over an extended period of time and water is wasted. In addition if a toilet or water heater cracks, water may flow out of the fixture not only causing a loss of water but possible damage to the building it is located within. Broken water pipes and/or heating pipes may break due to aging, rust or freezing. In the event a pipe fails there is an uncontrolled flow of water. The wear and tear on dishwashers and washing machines is one of the more common causes of water leakage.

There are several commercial products that are currently available for reducing the risk of water loss and water damage. However, these solutions are often specialized and need to be mounted or placed next to individual appliances in order to detect leakage. Currently devices exist that can be attached to a toilet or other appliance. These devices monitor for overflow or leakage conditions, and shut off the water supply to that fixture in the event moisture is detected. In addition, many of these devices require a powers supply which may be inconvenient.

Theses devices are dependent upon the leaking water coming into contact with the sensor in order to detect a fault. They are susceptible to false triggers, such as the build up of condensation in the summertime heat and humidity. They may also fail to identify the location of the problem.

The current technology requires that multiple devices be placed in areas with a greater likelihood that a water leak “may” occur. However, it does not protect against the water leak in a wall when a frozen pipe cracks or leaks that are contained such as a leaking sink or toilet valve.

### SUMMARY

According to an embodiment of the present invention is to provide methods to utilize pattern recognition capabilities to detect an excursion of water usage to shut-off water flow and prevent further water loss and/or damage.

A Water Flow Pattern Recognition (WFPR) system as determined by the inventors consists of a flow meter, an on/off valve, a console, an embedded computer and an optional shut-off timer. A flow meter may provide information about the flow rate in gallons per minute as the water enters the building. In one embodiment the flow meter is attached to the pipe (without cutting the pipe) at the main source where it enters the building.

An embedded computer with a processor, collects, records and classifies the flow rate measurement with respect to time (time stamp & per hour interval). The pattern recognition program extracts information to create a baseline and will shut off water flow if there is a water usage excursion. Water usage is classified by average flow rate and time. The flow rate may be calculated as gallons per minute. Time may be determined as the number of days (7 or 14 days intervals) and number of hours (24 hours intervals).

When there is a water usage excursion, in one embodiment the embedded computer sends a signal to the on/off valve to shut off water flow. It also displays the information on a console panel to indicate that there is a water usage excursion. The user may reset the control panel after the water loss/damage is fixed.

Another embodiment of the invention may be for the console is to allow the WFPR system to create a baseline after a 7-14 day period. The user can use the console to increase water usage for a specific day if it is not part of the routine so that the increased water flow is not shut-off. This factor may be built in so that there will be a “tolerance” of increased water usage before the water flow is shut-off.

In another embodiment the pattern recognition may be setup so that the tolerance can become tighter during a period of no water usage. The purpose is to detect minimal water flow over a several hour period when there is supposed to be no water flow.

### BRIEF DESCRIPTION OF THE SEVERAL VIEWS OF THE DRAWINGS

FIG. 1 is a schematic diagram of a system for monitoring water usage with pattern recognition according to an embodiment of the invention.

FIG. 2 illustrates one example of a controller which may comprise a microprocessor and memory internally (not shown), a keyboard, and a display according to an embodiment of the invention.

FIG. 3 is a flow diagram of a method for monitoring water usage with pattern recognition according to an embodiment of the invention.

FIG. 4 is a graph of a baseline water usage of a typical home according to an embodiment of the invention.

FIG. 5 is a graph of a representative actual water usage of a typical home according to an embodiment of the invention.

FIG. 6 is a graph of water usage spikes without the benefit of a cutoff system.

FIG. 7 is a graph of water usage with the introduction of a cutoff for a typical home according to an embodiment of the invention.

FIG. 8 is a graph of water usage with the introduction of a cutoff for a typical home and further illustrating cutoffs over time according to an embodiment of the invention.

### DETAILED DESCRIPTION

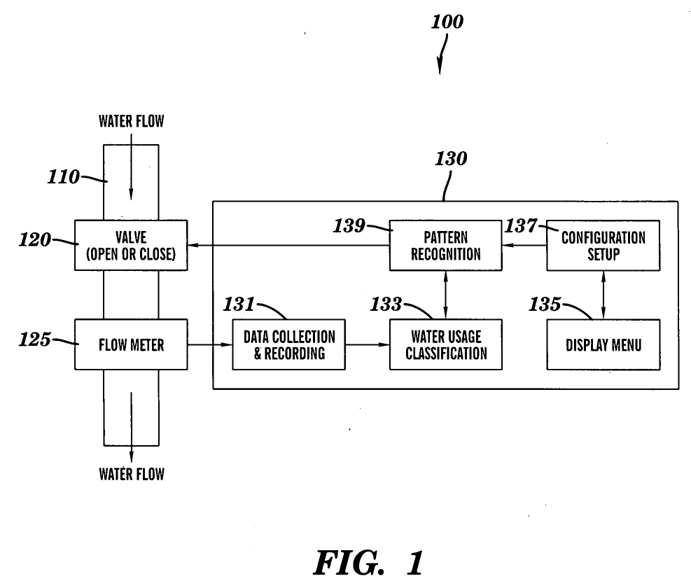

With reference now to FIG. 1 is a schematic diagram of a system 100 for monitoring water usage with pattern recognition according to an embodiment of the invention. Water flows through the main trunk 110 normally from either provided by the local government or by a well. While the embodiments described are directed to the flow of water, one of ordinary skill in the art would be readily able to adjust the invention to other fluids. A main valve 120 may be controlled by controller 130. Main valve 120 may be operated by an actuator. A flow meter 125 is positioned either before or after valve 120. An example of a commercial flow meter is the GE AquaTrans™ UTX878 Panametrics Ultrasonic Liquid Flow Transmitter. The flow meter 125 provides an output to controller 130. The output from flow meter 125 may be in the form of gallons per minute. The output from flow meter 125 may be instantaneous measurements or average flow rates over time.

Controller 130 may include a data collection and recorder 131, to collect and retain the information from flow meter 125. The data collection and recorder 131 may be a hard drive, ram, a magnetic recorder or other means capable of collecting data and providing the data when requested. The data collection and recorder may record both the flow rate and the time the data was collected. Data is provided by the data collection and recorder 131 to a processor to allow water usage classification software 133 to analyze the data and characterize the usage over time and possibly by hour of the day and day of the week. Pattern recognition software 139 analyzes the output from the water usage classification software 133 and determines if the water usage is outside the norm and beyond a cutoff. In the event the cutoff is exceeded, the controller 130 closes valve 120. The cutoff may be manually input by configuration setup software 137 or may be determined by analysis by the pattern recognition software 139. The configuration setup software 137 may be coupled to input means such as a personal computer or a keyboard not shown. The configuration setup 137 and the pattern recognition may provide an output which is displayed by means of a display menu 135 on a monitor or other display apparatus. Controller 130 could for example be contained within a package and may be attached to flow meter 125 and valve 120.

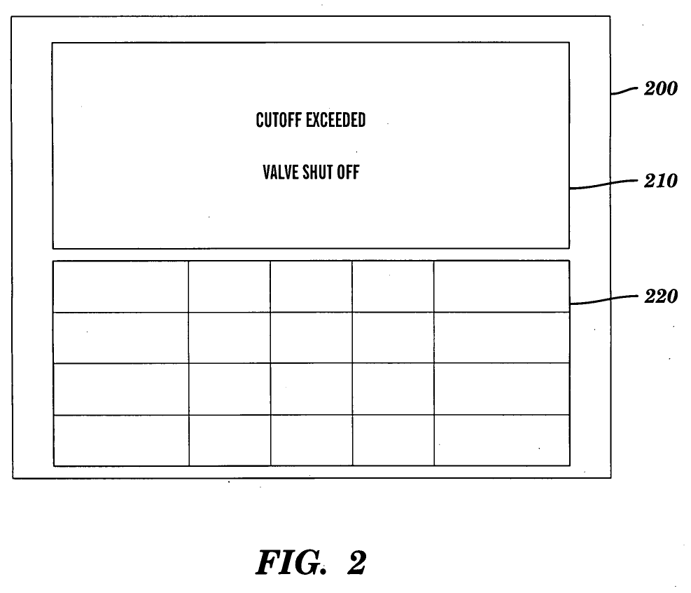

FIG. 2 illustrates one example of a controller 200 which may comprise a microprocessor and memory internally (not shown), a keyboard 220, and a display 210. The controller may be mounted on flow meter 125 of FIG. 1 or remotely for example on the wall in a similar manner as a thermostat. In a similar manner controller 200 may be mounted on valve 120 or may incorporate valve 120 and flow meter 125 of FIG. 1 into one unit.

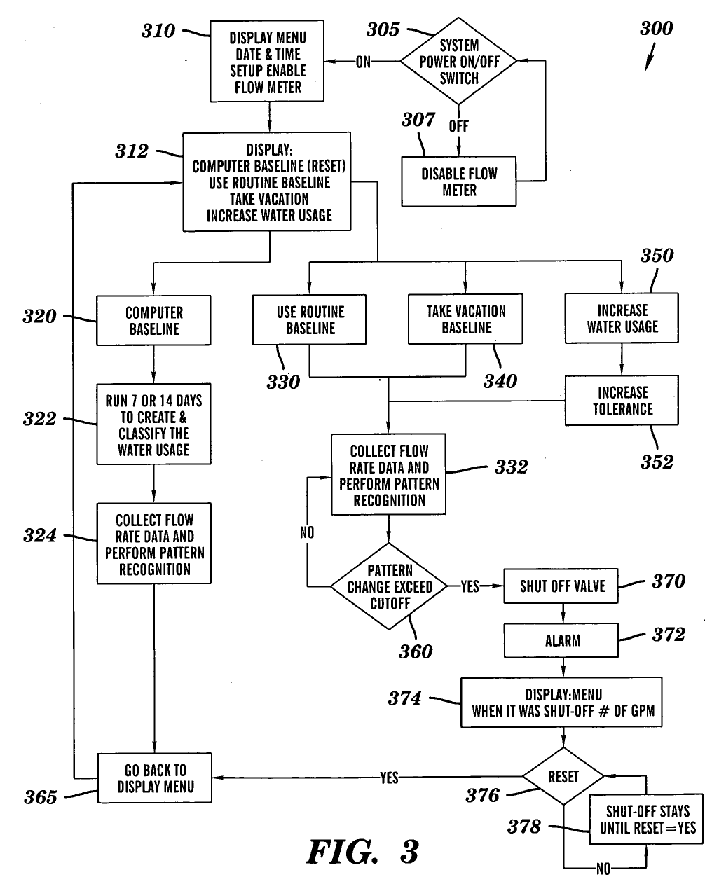

FIG. 3 is a flow diagram of a method 300 for monitoring water usage with pattern recognition according to an embodiment of the invention. Activity 305 is to determine if the system power is on of off. If the system is off, activity 307 disables the flow meter. If the system power is on, activity 310 displays the menu, date and time setup. Activity 312 displays the user options of resetting the computer baseline, take vacation, increase the water usage or use the route baseline. Activity 320 may be to compute the baseline water usage. Activity 322 may be to run the system for 7 or 14 days to create and classify the water usage. Activity 324 may be to collect the flow rate data and perform pattern recognition. Once a baseline is set activity 365 returns the user to activity 312 to operate one of the three alternative paths.

Alternatively activity 330 may be to use the routine baseline for monitoring. Activity 332 may be to collect flow rate data and perform pattern recognition. If the user plans to leave their home for an extended period of time, activity 340 may be to use the vacation baseline. The vacation baseline may be for minimal or no water usage dependant upon whether automated systems such as sprinkler systems may operate. Activity 332 may be to collect data and perform pattern recognition. In the event the user wishes to increase tolerances, either to eliminate false alarms or to the sprinkler system being enabled, activity 350 may be to increase the water usage parameters and activity 352 may be to increase the tolerance. Activity 332 may then collect flow rate data and perform pattern recognition.

Activity 360 may be to take the inputs form either activity 332 and determine if a pattern change indicates a cutoff has been exceeded. If a cutoff has not been exceeded, activity 332 continues to collect flow rate data. If a cutoff has been exceeded, activity 370 may be to shut off the main valve such as valve 120 of FIG. 1. Activity 372 may be to set an alarm and activity 374 may be to cause the display to indicate the valve was shut off and the reason why, such as the number of gallons per minute were flowing. Activity 376 may be to determine if the user has reset the system. If the system is not reset, activity 378 is to maintain the system off until a reset is received. When the system is reset activity 365 may be to return to the display activity 312. If the pattern change does not exceed a cutoff, activity 332 is to continue to collect flow rate data and perform pattern recognition.

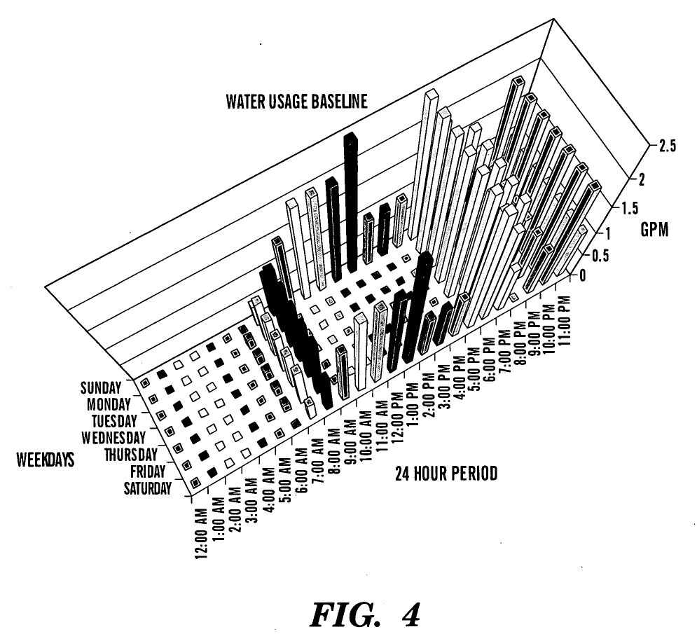

FIG. 4 is a graph of a baseline water usage of a typical home according to an embodiment of the invention. Activity 332 and 324 of FIG. 3 may have collected data similar to that illustrated in FIG. 4. As can be seen, certain patterns of water usage are noticeable, such as morning showers, and a higher rate of use in the evening when cooking. In order to use pattern recognition efficiently, it needs to have sufficient information about the water usage in order to create and classify the pattern of water usage. In this embodiment a minimum volume is 7 to 14 days worth of data. There is also an assumption is that there is no wasted water flow when the system is installed.

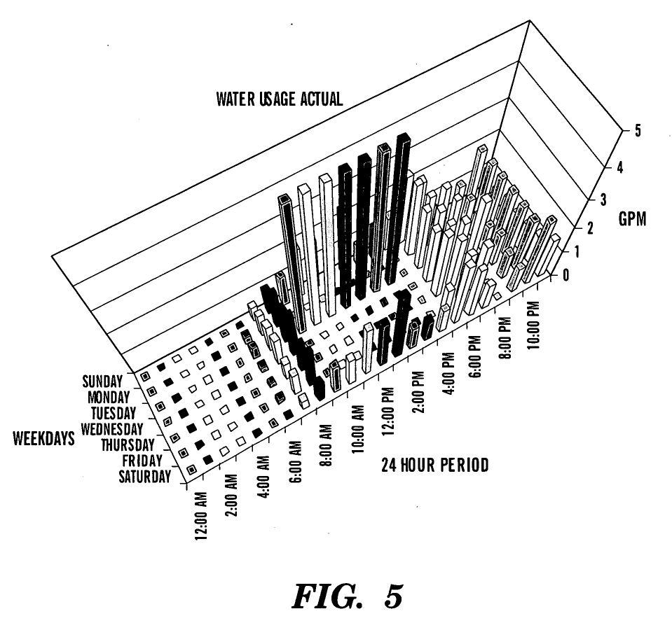

FIG. 5 is a graph of a representative actual water usage of a typical home according to an embodiment of the invention. As seen there may be an issue detected on Tuesday indicating a very high level of usage compared to the baseline set in FIG. 4.

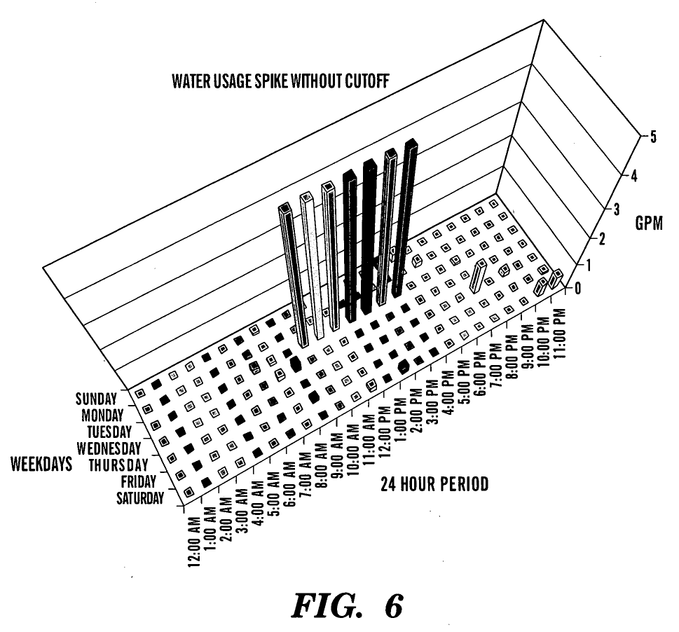

FIG. 6 is a graph of water usage spikes without the benefit of a cutoff system. As can be seen the spikes show times when the water usage is outside of the norm as set by FIG. 4. These spikes may indicate a leak, break or a sink left running.

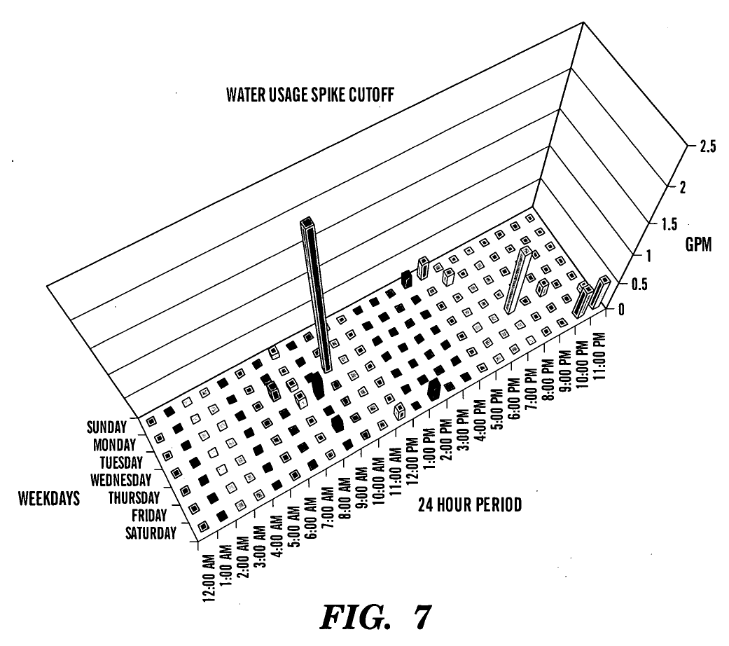

FIG. 7 is a graph of water usage with the introduction of a cutoff for a typical home according to an embodiment of the invention. As can be seen the total water usage in FIG. 7 is far less than in FIG. 6. By utilizing an embodiment of the invention, leaks, breaks and unintentional waste is prevented.

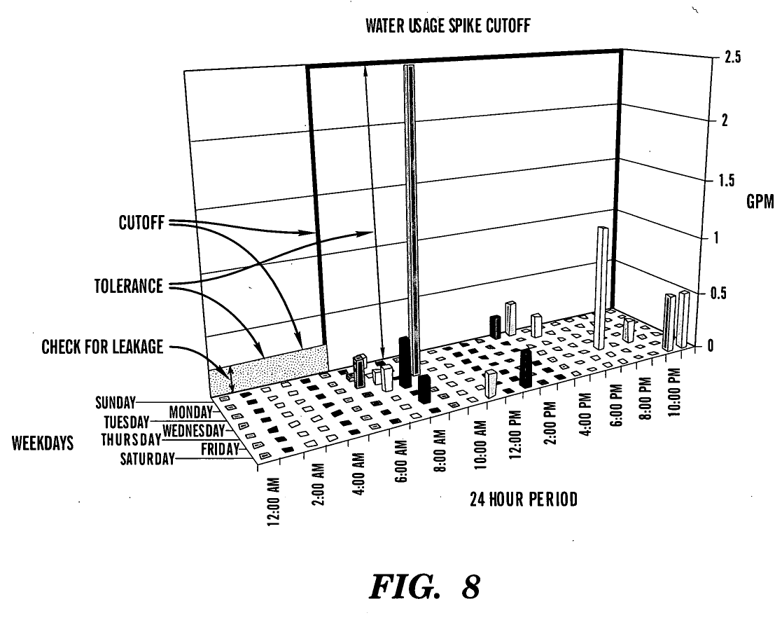

FIG. 8 is a graph of water usage with the introduction of a cutoff for a typical home and further illustrating cutoffs over time according to an embodiment of the invention. The cutoff's may be set by the user or determined by the system utilizing a method such as the one taught in FIG. 3. As can be seen the cutoff is lower from midnight until 6:00 am. This allows the system to identify slow leaks. During peak usage times, the cutoff may be set higher to allow the user to utilize water while still detecting catastrophic leaks. In one embodiment the water usage may be set at zero during times that the house is normal vacant. This would permit the home owner to identify very slow leaks, which may result in mold, or damaged walls.

As an example, in FIG. 4, there is no water flow from 12:00 midnight to 5:00 A.M. everyday when people are typically in bed. During that time, this is an opportunity for the system to check to see if there is any water flow over that 4 hour period that may in fact be a slow water leak or faucet accidentally left running. In case of a situation when the homeowner has to flush the toilet several times due to illness within a short period of time, it creates a pattern of several bursts of water usage. This pattern does not match the pattern of low water flow in that 4 hour period and also it does not match the cut-off pattern of water usage. The system will not initiate the shutdown action.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A Method comprising the steps:
a. monitoring water usage over a period of time;
b. determining a first pattern of usage;
c. comparing water usage to the pattern of usage; and
d. shutting a valve based on the comparing of water usage.

2. The method of claim 1, further comprising:
a. setting a second pattern of usage; and
b. selecting either the first or second pattern of usage for comparing.

3. The method of claim 2, wherein the first pattern of usage is determined by monitoring usage over a period of time and the second pattern of usage is predetermined.

4. The method of claim 3, wherein the second pattern of usage designates a vacation baseline.

5. The method of claim 1, wherein cutoffs are set based on the pattern of usage.

6. The method of claim 5, wherein the cutoffs may be adjusted.

7. An apparatus comprising:
a. a flow meter to monitor the flow of a liquid;
b. a controller coupled to the flow meter and adapted to open or close a valve, wherein the controller receives flow information from the flow meter and identifies patterns of usage and provides a signal to open or close said valve.

8. The apparatus of claim 7, wherein the controller further comprises a memory to store data and patterns.

9. The apparatus of claim 7, wherein the controller further comprises a processor, the processor adapted to compare water usage with baseline data.

10. The apparatus of claim 7, wherein the fluid is water.

11. The apparatus of claim 9, wherein the controller sets cutoffs based on the baseline data, and wherein the controller is adapted to shutoff a valve when the cutoff is exceeded.

12. The apparatus of claim 11, wherein the cutoff may be raised or lowered.

13. A system comprising:
a. a valve adapted to be operated with an actuator;
b. a flow meter adapted to monitor the flow of a fluid through a valve; and
c. a controller adapted to receive an output from the flow meter and adapted to shut the valve when a pattern of usage is determined to be above a cutoff.

14. The system of claim 13, wherein the fluid is water.

15. The system of claim 14, wherein the pattern of usage is determined over a 7 day week.

16. The system of claim 13 further comprising an input and a display, the input for inputting parameters and configurations for the controller and the display to display menus and status of the system.

17. The system of claim 16 wherein the input is adapted to adjust the cutoff.
